(19) United States
(12) Patent Application Publication
(10) Pub. No.: US 2016/0264709 A1
(43) Pub. Date: Sep. 15, 2016

(54) POLYUREA PREPOLYMERS MADE FROM PRIMARY AND SECONDARY DIAMINES

(71) Applicant: SUPER SKIN SYSTEMS, INC., LAWRENCEVILLE, GA (US)

(72) Inventor: STUART BRUCE SMITH, LAWRENCEVILLE, GA (US)

(73) Assignee: SUPER SKIN SYSTEMS, INC., LAWRENCEVILLE, GA (US)

(21) Appl. No.: 15/068,853

(22) Filed: Mar. 14, 2016

Related U.S. Application Data
(60) Provisional application No. 62/131,987, filed on Mar. 12, 2015.

(51) Int. Cl. C08G 18/38; C08G 18/61

(52) U.S. Cl. CPC C08G 18/3819; C08G 18/3821; C08G 18/61

(57) ABSTRACT

Novel polyurea prepolymer and quasi-prepolymers are contemplated, the compositions being the reaction products of various isocyanate components with various polyamine components. Isocyanate components contemplated include uretonimine-modified 4,4′ methylene diphenyl diisocyanate (MDI) 4,4′ MDI, 2,4′ MDI, aliphatic hexamethylene diisocyanate (HDI) trimer, HDI allophanate, and aliphatic HDI biuret. Polyamine components contemplated include primary amine-terminated poly(oxypropylene), secondary isopropylamine-terminated poly(oxypropylene), tetraethyl N,N′-(methylenebis(2-methyl-4,1-cyclohexanediyl)) bisaspartate, and poly[(3-aminopropyl)methylsiloxane-co-diphenylsiloxane].

### CROSS-REFERENCE TO RELATED APPLICATIONS

This patent application claims priority to U.S. Provisional Patent Application Ser. No. 62/131,987, entitled POLYUREA PREPOLYMERS MADE FROM PRIMARY AND SECONDARY DIAMINES, filed on Mar. 12, 2015, all of the teachings of which are incorporated herein by reference.

### STATEMENT RE: FEDERALLY SPONSORED RESEARCH/DEVELOPMENT

Not Applicable

### BACKGROUND

1. Technical Field

The present disclosure relates generally to the field of polyurea coatings and composites, and methods of making the same. More particularly, the present disclosure relates to the preparation of novel polyurea prepolymers and quasi-prepolymers.

2. Related Art

Polyureas are the reaction product of amine-containing terminated polyols reacted with isocyanates. Polyureas were developed in the 1980s for rapid process application of durable protective membranes for a myriad of products and technologies. Conventional polyurea coatings typically possess several characteristics that have made them desirable as a seamless membrane including fast, consistent reactivity and cure, moisture and temperature insensitivity during application, exceptional elastomeric quality, hydrolytically stability (i.e. low water absorption), high thermal stability, an auto catalytic nature, and non-emission of solvents or volatile organic compounds when applied.

Polyureas are generally formed as the reaction product of an isocyanate component and a polyamine resin blend. While the polyurea reaction will work with polyamine monomers or polymers, it is quite exothermic and unlikely to form orderly structures when reacted without a mechanism or environment tailored to remove excess chemical energy (usually released as thermal energy), and may even pose fire hazards when reacted in the presence of flammable substances. It is thus desirable in many industrial fields to perform the reaction in multiple stages, which serves to decrease the isocyanate content and thus the chemical energy released by the polyurea reaction in steps, preventing all the chemical energy from being released during one single step of forming the polyurea. This is generally accomplished by forming polyamine prepolymers or quasi-prepolymers. This provide the polyamine in a partially reacted, viscous form where it may be conveniently mixed with a polyamine resin blend while liberating less heat when curing into a completely hardened reaction product.

An isocyanate polyurea prepolymer is generally formed from a molar ratio of isocyanate component to polyamine component just sufficient to fully saturate every functional amine of the polyamine component with an exposed isocyanate functional groups. Isocyanate quasi-prepolymers are similar to prepolymers, except that the isocyanate component is provided in a greater molar ratio than in the prepolymer, resulting in some free isocyanate component in the quasi-prepolymer. This generally allows the quasi-prepolymer to be more viscous at room temperature and thus easier to mix, with the greater isocyanate content increasing the reactivity, which often allows the final mixing step for forming the cured reaction product to occur at or near room temperature. Further, the additional free isocyanate component may permit greater tolerances in the formulation of the final mixing step for the cured reaction product.

In order to obtain cured polyurea reaction products having material characteristics beneficial for various purposes, it is desirable to utilize various different polyurea prepolymers or quasi-prepolymers, the choice of which may result in cured polyurea reaction products having vastly different material characteristics.

Therefore, novel prepolymers and quasi-prepolymers are desirable.

### BRIEF SUMMARY

To solve these and other problems, novel polyurea prepolymers are is contemplated, the prepolymers comprising the reaction product of a isocyanate component and a secondary diamine component, wherein the isocyanate component is selected from one or more of the group of uretonimine-modified 4,4′ methylene diphenyl diisocyanate (MDI), 4,4′ MDI, 2,4′ MDI, aliphatic hexamethylene diisocyanate (HDI) trimer, HDI allophanate, aliphatic HDI biuret, and wherein the polyamine component is selected from one or more of the group of: primary amine-terminated poly(oxypropylene), secondary isopropylamine-terminated poly(oxypropylene), tetraethyl N,N′-(methylenebis(2-methyl-4,1-cyclohexanediyl)) bisaspartate, poly[(3-aminopropyl)methylsiloxane-co-diphenylsiloxane].

In a first exemplary embodiment, a polyurea prepolymer is contemplated to be formed from an isocyanate component which comprises a mixture of uretonimine-modified 4,4′ MDI having an isocyanate content of about 29% and a polyamine component comprising a mixture of secondary isopropylamine-terminated poly(oxypropylene) having the general formula:

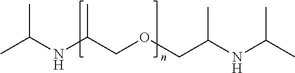

where n has a mean value of about 33, and wherein the polyurea prepolymer has an isocyanate content of about 16%.

In a second exemplary embodiment, a polyurea prepolymer is contemplated to be formed from an isocyanate component which comprises a mixture of 2,4′ MDI and 4,4′ MDI having an isocyanate content of about 32-33% and a polyamine component comprising a mixture of secondary isopropylamine-terminated poly(oxypropylene) having the general formula:

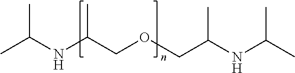

where n has a mean value of about 33, and wherein the polyurea prepolymer has an isocyanate content of about 16%.

In a third exemplary embodiment, a polyurea prepolymer is contemplated to be formed from an isocyanate component which comprises a mixture of uretonimine-modified 4,4′ MDI having an isocyanate content of about 29% and a polyamine component comprising a mixture of primary-amine terminated poly(oxypropylene) having the general formula:

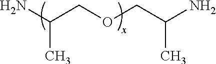

where x has a mean value of about 33.

In a fourth exemplary embodiment, a polyurea prepolymer is contemplated to be formed from an isocyanate component which comprises a a mixture of 2,4′ MDI and 4,4′ MDI having an isocyanate content of about 32-33% and a polyamine component comprising a mixture of primary-amine terminated poly(oxypropylene) having the general formula:

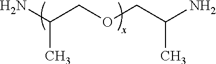

where x has a mean value of about 33.

In a fifth exemplary embodiment, a polyurea prepolymer is contemplated to be formed from an isocyanate component which comprises aliphatic hexamethylene diisocyanate (HDI) trimer having an isocyanate content of about 32-33% and a polyamine component comprising a mixture of secondary isopropylamine-terminated poly(oxypropylene) having the general formula:

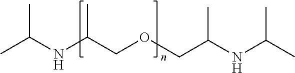

where n has a mean value of about 33, and wherein the polyurea prepolymer has an isocyanate content of about 12%.

In a sixth exemplary embodiment, a polyurea prepolymer is contemplated to be formed from an isocyanate component which comprises HDI allophanate and a polyamine component comprising a mixture of secondary isopropylamine-terminated poly(oxypropylene) having the general formula:

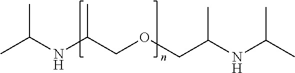

where n has a mean value of about 33, and wherein the polyurea prepolymer has an isocyanate content of about 12%.

In a seventh exemplary embodiment, a polyurea prepolymer is contemplated to be formed from an isocyanate component which comprises HDI biuret and a polyamine component comprising a mixture of secondary isopropylamine-terminated poly(oxypropylene) having the general formula:

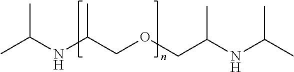

where n has a mean value of about 33, and wherein the polyurea prepolymer has an isocyanate content of about 12%.

In an eight exemplary embodiment, a polyurea prepolymer is contemplated to be formed from an isocyanate component which comprises aliphatic HDI trimer having an isocyanate content of about 21.4% and a polyamine component comprising tetraethyl N,N′-(methylenebis(2-methyl-4,1-cyclohexanediyl)) bisaspartate, and wherein the polyurea prepolymer has an isocyanate content of about 16%.

In a ninth exemplary embodiment, a polyurea prepolymer is contemplated to be formed from an isocyanate component which comprises HDI allophanate and a polyamine component comprising tetraethyl N,N′-(methylenebis(2-methyl-4,1-cyclohexanediyl)) bisaspartate, and wherein the polyurea prepolymer has an isocyanate content of about 16%.

In a tenth exemplary embodiment, a polyurea prepolymer is contemplated to be formed from an isocyanate component which comprises HDI biuret and a polyamine component comprising tetraethyl N,N′-(methylenebis(2-methyl-4,1-cyclohexanediyl)) bisaspartate, and wherein the polyurea prepolymer has an isocyanate content of about 16%.

In an eleventh exemplary embodiment, a polyurea prepolymer is contemplated to be formed from an isocyanate component which comprises aliphatic HDI trimer having a isocyanate content of about 21.4% and a polyamine component comprising poly[(3-aminopropyl)methylsiloxane-co-diphenylsiloxane].

In a twelfth exemplary embodiment, a polyurea prepolymer is contemplated to be formed from an isocyanate component which comprises HDI allophanate and a polyamine component comprising poly[(3-aminopropyl)methylsiloxane-co-diphenylsiloxane].

In a thirteenth exemplary embodiment, a polyurea prepolymer is contemplated to be formed from an isocyanate component which comprises HDI biuret and a polyamine component comprising poly[(3-aminopropyl)methylsiloxane-co-diphenylsiloxane].

In a fourteenth exemplary embodiment, a polyurea prepolymer is contemplated to be formed from an isocyanate component which comprises 2,4′ MDI and a polyamine component comprising poly[(3-aminopropyl)methylsiloxane-co-diphenylsiloxane].

In a fifteenth exemplary embodiment, a polyurea prepolymer is contemplated to be formed from an isocyanate component which comprises 4,4′ MDI and a polyamine component comprising poly[(3-aminopropyl)methylsiloxane-co-diphenylsiloxane].

In a sixteenth exemplary embodiment, a polyurea prepolymer is contemplated to be formed from an isocyanate component which comprises 2,4′ MDI and a polyamine component comprising tetraethyl N,N′-(methylenebis(2-methyl-4,1-cyclohexanediyl)) bisaspartate.

In a seventeenth exemplary embodiment, a polyurea prepolymer is contemplated to be formed from an isocyanate component which comprises 4,4′ MDI and a polyamine component comprising tetraethyl N,N′-(methylenebis(2-methyl-4,1-cyclohexanediyl)) bisaspartate.

In further embodiments, it is contemplated that the above formulations may also be implemented as quasi-prepolymers.

### DETAILED DESCRIPTION

According to various aspects of the present disclosure, new types of polyurea prepolymers and quasi-prepolymers are contemplated. In exemplary embodiments, a prepolymer or quasi-prepolymer is contemplated as comprising the reaction product of an isocyanate component and a polyamine component, with the isocyanate components contemplated including one or more of uretonimine-modified 4,4′ methylene diphenyl diisocyanate (MDI), 4,4′ MDI, 2,4′ MDI, aliphatic hexamethylene diisocyanate (HDI) trimer, HDI allophanate, and aliphatic HDI biuret. Polyamine components contemplated include one or more of primary amine-terminated poly(oxypropylene), secondary isopropylamine-terminated poly(oxypropylene), tetraethyl N,N′-(methylenebis(2-methyl-4,1-cyclohexanediyl)) bisaspartate, and poly[(3-aminopropyl)methylsiloxane-co-diphenylsiloxane].

One measure of the reactivity of an isocyanate or mixture of isocyanates in a polymerization reaction is its isocyanate content, also referred to as NCO content, isocyanate value, or NCO %. Isocyanate content can be determined by the following equation, where 42 is the molecular weight of an NCO group, f is the functionality of the isocyanate composition, and Mw is the molecular weight of the isocyanate composition:

$$Isocyanate Value = \% NCO groups = \frac{42 \times f}{Mw} \times 100 ,$$

Polyurea prepolymers and quasi-prepolymers may be formed as the reaction product of an isocyanate component and a polyamine component, such that a given percentage by weight (the isocyanate content) of the isocyanate functional groups remain unreacted and ready for further reaction isocyanate reactions.

4,4′ methylene diphenyl diisocyanate (MDI), also referred to as bis(1,4-isocyanatophenyl)methane, along with other names, is a common isocyanate used in various polymerization reactions to form polyurethanes. Pure 4,4′ MDI has a 33.6% isocyanate content and the following chemical structure:

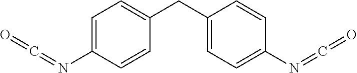 [SMILES: O=C=Nc1ccc(Cc2ccc(N=C=O)cc2)cc1]

2,4′ MDI is a common isomer of MDI that is also frequently used as an isocyanate in various urethane polymerization reactions to form polyurethanes, alone or in various combinations with 4,4′ MDI or other isomers of MDI, or other isocyanates. Pure 2,4′ MDI has a 33.6% isocyanate content, and the following chemical structure:

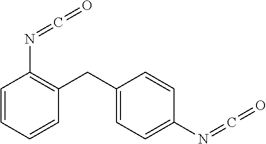 [SMILES: O=C=Nc1ccc(Cc2ccccc2N=C=O)cc1]

Uretonimine-modified 4,4′ MDI generally consists of a composition of reaction products formed from the catalyzed reaction of pure 4,4′ MDI, wherein the terminal isocyanate groups of multiple 4,4′ MDI molecules react with each other to form multifunctional uretonimine oligomers via a carbodiimide intermediate, starting with 3-functional, 6-ring uretonimine oligomers and ranging to very complex high functional oligomers. The longer the reaction is allowed to proceed before being stopped (typically via quenching), the more complex and multifunctional the aggregate reaction product will be, and the lower the resulting NCO content will be.

One way the uretonimine modification of 4,4′ MDI is generally understood to proceed is as follows:

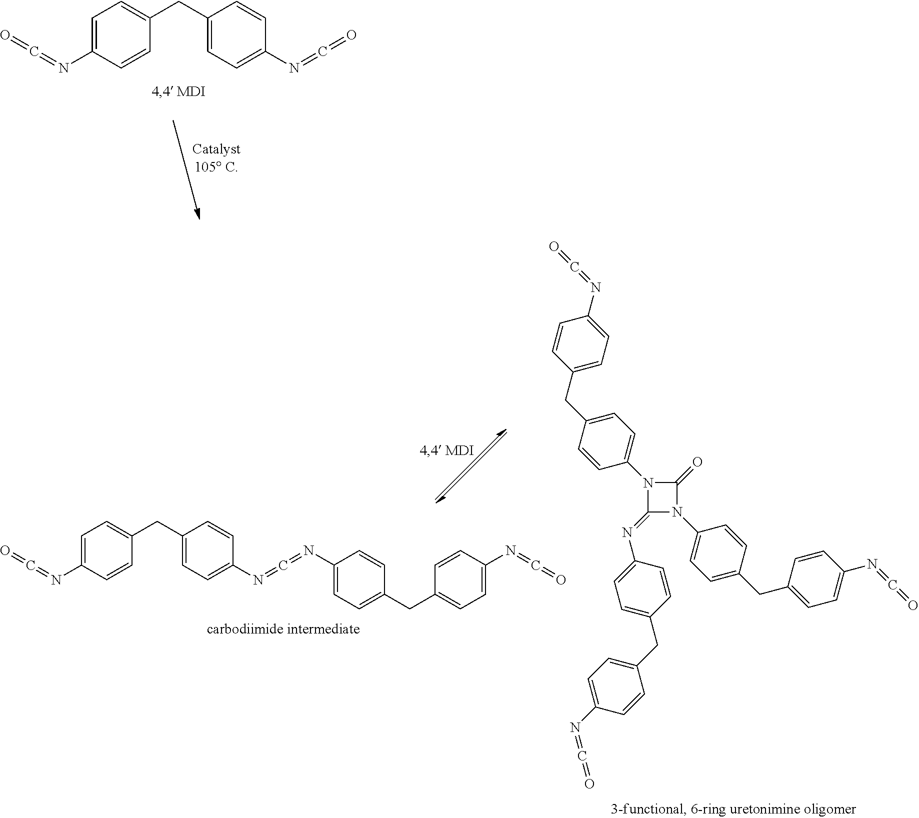 [SMILES: O=C=Nc1ccc(Cc2ccc(N=C=O)cc2)cc1 ; O=C=Nc1ccc(Cc2ccc(N=C=Nc3ccc(Cc4ccc(N=C=O)cc4)cc3)cc2)cc1 ; O=C=Nc1ccc(Cc2ccc(N=C3N(c4ccc(Cc5ccc(N=C=O)cc5)cc4)C(=O)N3c3ccc(Cc4ccc(N=C=O)cc4)cc3)cc2)cc1]

As the uretonimine reaction proceeds further, more monomeric 4,4′ MDI is consumed and converted to uretonimines, and more functional and complex uretonimine-modified 4,4′ MDI oligomers are formed, including 4-functional, ten ring uretonimine oligomers and 5-functional, 12-ring oligomers, and higher functionality, more complex uretonimines. Consequently, the NCO content of the mixture of uretonimine-modified 4,4′ MDIs drops as well. For example, while pure 4,4′ MDI has an isocyanate content of 33.6%, one embodiment of a mixture of uretonimine-modified 4,4′ MDIs have an isocyanate content of about 29%. In other embodiments, however, it may be seen that the isocyanate content of a mixture of uretonimine-modified 4,4′ MDIs may have varying isocyanate contents depending on the length of time the uretonimine reaction is allowed to proceed prior to termination, along with other conditions.

Hexamethylene diisocyanate (HDI) is another common isocyanate used in various polymerization reactions to form polyurethanes. Like MDI, more complex HDI-based compounds may be comprise the isocyanate component in the formation of prepolymers and quasi-prepolymers according to the present disclosure. For example, aliphatic HDI Trimer, also called HDI isocyanurate, may comprise the isocyanate component according to the present disclosure. HDI trimer may, in certain embodiments, have an isocyanate content of about 21.4%. HDI Trimer may be formed according to known methods of trimerization, which proceed according to the general reaction as follows:

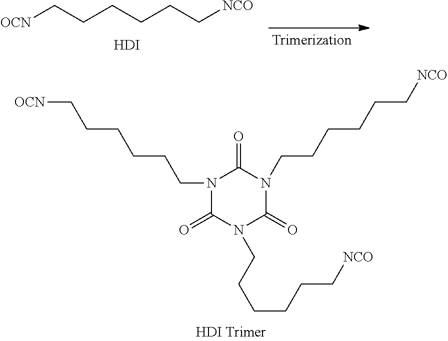

Another more complex HDI-based compound which may be useful as an isocyanate component according to the present disclosure may be HDI allophanate. HDI allophanate may be formed according to known methods of allophanation, which proceed according to the general reaction as follows:

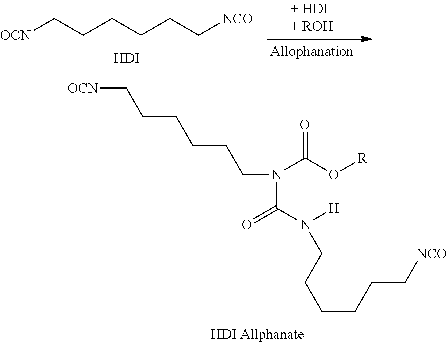

A further complex HDI-based compound which may be useful as an isocyanate compound according to the present disclosure may be HDI biuret, also called tris(isocyanatohexyl)biuret or 1,3,5-tris(6-hydrohexyl)biuret triisocyanate, among other names. HDI biuret has the following chemical formula:

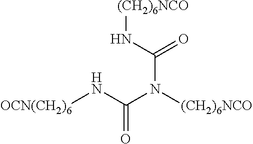

One useful category of polyamines in the formation of the presently disclosed prepolymers and quasi-prepolymers is primary amine-terminated poly(oxypropylene), which are oxypropylene polymers which terminate in an primary amine functional group, and may have the following general formula:

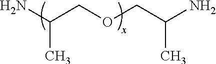

Mixtures of primary amine-terminated poly(oxypropylene), generally as a result of the conditions and process used in polymerization, include polymeric units having varying numbers of repeating monomeric subunits. As a result, the aggregate mixture may vary in mean, median, and standard deviation of number of repeating units (x), which correlates directly with molecular weight. This, likewise, may affect the material properties of any resulting polyurea formed from such an aggregate mixture. In one particular embodiment of the present disclosure, it is contemplated that a primary amine-terminated poly(oxypropylene) mixture may have a mean value of x of about 33. However, it may be seen that other aggregate mixtures of primary amine-terminated poly(oxypropylene), the mean value of x, as well as other values such as the median value of x or the standard deviation of x may differ, but still may be utilized without departing from the scope and spirit of the present disclosure.

Another useful category of polyamines in the formation of the presently disclosed prepolymers and quasi-prepolymers are secondary isopropylamine-terminated poly(oxypropylene) are oxypropylene polymers which terminate in an secondary isopropylamine functional group, and may have the following general formula:

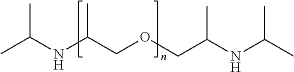

Secondary isopropylamine-terminated poly(oxypropylene), generally as a result of the conditions and process used in polymerization, include polymeric units having varying numbers of repeating monomeric subunits. As a result, the aggregate mixture may vary in mean, median, and standard deviation of number of repeating units (n), which correlates directly with molecular weight. This, likewise, may affect the material properties of any resulting polyurea polymer, prepolymer, or quasi-prepolyer, formed from such an aggregate mixture. In one particular embodiment of the present disclosure, it is contemplated that a secondary isopropylamine-terminated poly(oxypropylene) mixture may have a mean value of n of about 33. However, it may be seen that other aggregate mixtures of secondary isopropylamine-terminated poly(oxypropylene), the mean value of n, as well as other values such as the median value of n or the standard deviation of n may differ, but still may be utilized without departing from the scope and spirit of the present disclosure.

A further useful polyamine in the formation of the presently disclosed prepolymers and quasi-prepolymers is tetraethyl N,N′-(methylenebis(2-methyl-4,1-cyclohexanediyl)) bisaspartate is a polyaspartic secondary diamine which has the general formula:

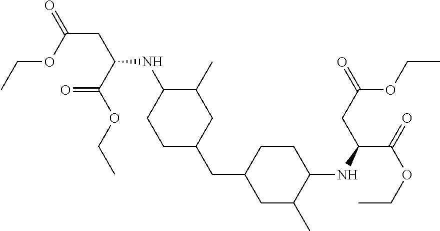

A further useful polyamine in the formation of presently disclosed prepolymers and quasi-prepolyers is poly[(3-aminopropyl)methylsiloxane-co-diphenylsiloxane], which is a siloxane copolymer having the general formula:

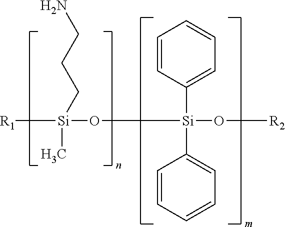

It may be seen that in certain embodiments, the poly[(3-aminopropyl)methylsiloxane-co-diphenylsiloxane] used may be many types of copolymer having varied distributions and arrangements of the (3-aminopropyl)methylsiloxane) and the diphenylsiloxane units, and that the arrangement, distribution, and number of these units may affect the final material properties of a cured polyurea reaction product incorporating poly[(3-aminopropyl)methylsiloxane-co-diphenylsiloxane] may change depending on the specific arrangement and distribution of those units. For example, a random copolymer may be utilized wherein the chance of finding a particular monomer at any given location in the polymer is directly proportional to the molar fraction of that monomer. It may also be seen that other arrangements, such as regularly alternating copolymers or periodic copolymers may be used, where the monomeric units are arranged in a repeating sequence. Likewise, it may also be seen that block copolymers or statistical copolymers may be utilized. Additionally, linear or branched copolymers may be preferred, depending on the needs of the application. Poly[(3-aminopropyl)methylsiloxane-co-diphenylsiloxane] may be synthesized via known methods of siloxane polymerization, or may be obtained commercially.

It is contemplated that certain ones of the prepolymer and quasi-prepolyer reactions as presently contemplated may not require the use of a reactor or catalyst, but may instead be performed at room temperature via direct shear mixing. For example, according to the first exemplary embodiment disclosed above, uretonimine-modified 4,4′ MDI having an isocyanate content of about 29% and a polyamine component comprising a mixture of secondary isopropylamine-terminated poly(oxypropylene) having a mean molecular weight of about 2000 were mixed at room temperature with a shear mixer at about 800 RPM for 15 minutes. However, it may be seen that in other embodiments, such as those discussed above, the methods and conditions of the reaction to form the prepolymer or quasi-prepolymer may be varied, without departing from the scope and spirit of the present disclosure. For example, it may be seen that when using more reactive components (generally higher isocyanate contents or less substituted amines), the reaction time to form a prepolyer or quasi-prepolymer may be reduced, and vice-versa for less reactive components.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the exemplary embodiments.

What is claimed is:

1. A polyurea prepolymer comprising the reaction product of a isocyanate component and a polyamine component;
wherein the isocyanate component is selected from one or more of the group of: uretonimine-modified 4,4′ methylene diphenyl diisocyanate (MDI), 4,4′ MDI, 2,4′ MDI, aliphatic hexamethylene diisocyanate (HDI) trimer, HDI allophanate, aliphatic HDI biuret, and;
wherein the polyamine component is selected from one or more of the group of: primary amine-terminated poly(oxypropylene), secondary isopropylamine-terminated poly(oxypropylene), tetraethyl N,N′-(methylenebis(2-methyl-4,1-cyclohexanediyl)) bisaspartate, poly[(3-aminopropyl)methylsiloxane-co-diphenylsiloxane].

2. The polyurea prepolymer of claim 1,
wherein the isocyanate component comprises a mixture of uretonimine-modified 4,4′ MDI having an isocyanate content of about 29%;
wherein the polyamine component comprises a mixture of secondary isopropylamine-terminated poly(oxypropylene) having the general formula: 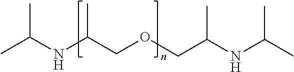
where n has a mean value of about 33; and
wherein the polyurea prepolymer has an isocyanate content of about 16%.

3. The polyurea prepolymer of claim 1,
wherein the isocyanate component comprises a mixture of 2,4′ MDI and 4,4′ MDI having an isocyanate content of about 32-33%;
wherein the polyamine component comprises a mixture of primary amine-terminated poly(oxypropylene) having the general formula: 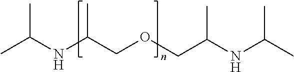
where n has a mean value of about 33; and
wherein the polyurea prepolymer has an isocyanate content of about 16%.

4. The polyurea prepolymer of claim 1,
wherein the isocyanate component comprises a mixture of uretonimine-modified 4,4′ MDI having an isocyanate content of about 29%; and
wherein the polyamine component comprises a mixture of primary amine-terminated poly(oxypropylene) having the general formula: 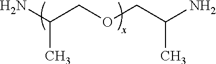
where x has a mean value of about 33.

5. The polyurea prepolymer of claim 1,
wherein the isocyanate component comprises a mixture of 2,4′ MDI and 4,4′ MDI having an isocyanate content of about 32-33%; and
wherein the polyamine component comprises a mixture of primary amine-terminated poly(oxypropylene) having the general formula: 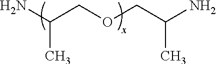
where x has a mean value of about 33.

6. The polyurea prepolymer of claim 1,
wherein the isocyanate component comprises aliphatic HDI trimer having a isocyanate content of about 21.4%;
wherein the polyamine component comprises a mixture of secondary isopropylamine-terminated poly(oxypropylene) having the general formula: 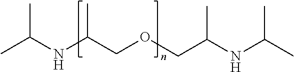
where n has a mean value of about 33; and
wherein the polyurea prepolymer has an isocyanate content of about 12%.

7. The polyurea prepolymer of claim 1,
wherein the isocyanate component comprises HDI allophanate;
wherein the polyamine component comprises a mixture of secondary isopropylamine-terminated poly(oxypropylene) having the general formula: 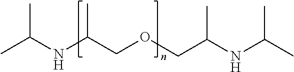
where n has a mean value of about 33; and
wherein the polyurea prepolymer has an isocyanate content of about 12%.

8. The polyurea prepolymer of claim 1,
wherein the isocyanate component comprises HDI biuret;
wherein the polyamine component comprises a mixture of secondary isopropylamine-terminated poly(oxypropylene) having the general formula: 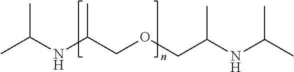
where n has a mean value of about 33; and
wherein the polyurea prepolymer has an isocyanate content of about 12%.

9. The polyurea prepolymer of claim 1,
wherein the isocyanate component comprises aliphatic HDI trimer having a isocyanate content of about 21.4%;
wherein the polyamine component comprises tetraethyl N,N′-(methylenebis(2-methyl-4,1-cyclohexanediyl)) bisaspartate; and
wherein the polyurea prepolymer has an isocyanate content of about 16%.

10. The polyurea prepolymer of claim 1,
wherein the isocyanate component comprises HDI allophanate;
wherein the polyamine component comprises tetraethyl N,N′-(methylenebis(2-methyl-4,1-cyclohexanediyl)) bisaspartate; and
wherein the polyurea prepolymer has an isocyanate content of about 16%.

11. The polyurea prepolymer of claim 1,
wherein the isocyanate component comprises HDI biuret;
wherein the polyamine component comprises tetraethyl N,N′-(methylenebis(2-methyl-4,1-cyclohexanediyl)) bisaspartate; and
wherein the polyurea prepolymer has an isocyanate content of about 16%.

12. The polyurea prepolymer of claim 1,
wherein the isocyanate component comprises aliphatic HDI trimer having a isocyanate content of about 21.4%;
wherein the polyamine component comprises poly[(3-aminopropyl)methylsiloxane-co-diphenylsiloxane]; and
wherein the polyurea prepolymer has an isocyanate content of about 16%.

13. The polyurea prepolymer of claim 1,
wherein the isocyanate component comprises HDI allophanate; and
wherein the polyamine component comprises poly[(3-aminopropyl)methylsiloxane-co-diphenylsiloxane].

14. The polyurea prepolymer of claim 1,
wherein the isocyanate component comprises HDI biuret; and
wherein the polyamine component comprises poly[(3-aminopropyl)methylsiloxane-co-diphenylsiloxane].

15. The polyurea prepolymer of claim 1,
wherein the isocyanate component comprises 2,4′ MDI; and
wherein the polyamine component comprises poly[(3-aminopropyl)methylsiloxane-co-diphenylsiloxane].

16. The polyurea prepolymer of claim 1,
wherein the isocyanate component comprises 4,4′ MDI; and
wherein the polyamine component comprises poly[(3-aminopropyl)methylsiloxane-co-diphenylsiloxane].

17. The polyurea prepolymer of claim 1,
wherein the isocyanate component comprises 2,4′ MDI;
wherein the polyamine component comprises tetraethyl N,N′-(methylenebis(2-methyl-4,1-cyclohexanediyl)) bisaspartate; and
wherein the polyurea prepolymer has an isocyanate content of about 16%.

18. The polyurea prepolymer of claim 1,
wherein the isocyanate component comprises 4,4′ MDI;
wherein the polyamine component comprises tetraethyl N,N′-(methylenebis(2-methyl-4,1-cyclohexanediyl)) bisaspartate; and
wherein the polyurea prepolymer has an isocyanate content of about 16%.

19. A polyurea quasi-prepolymer comprising the reaction product of a isocyanate component and a polyamine component;
wherein the isocyanate component is selected from one or more of the group of: uretonimine-modified 4,4′ methylene diphenyl diisocyanate (MDI), 4,4′ MDI, 2,4′ MDI, aliphatic hexamethylene diisocyanate (HDI) trimer, HDI allophanate, aliphatic HDI biuret, and;
wherein the polyamine component is selected from one or more of the group of: primary amine-terminated poly(oxypropylene), secondary isopropylamine-terminated poly(oxypropylene), tetraethyl N,N′-(methylenebis(2-methyl-4,1-cyclohexanediyl)) bisaspartate, poly[(3-aminopropyl)methylsiloxane-co-diphenylsiloxane].
